(19) United States
(12) Patent Application Publication
(10) Pub. No.: US 2026/0025195 A1
(43) Pub. Date: Jan. 22, 2026

(54) CONTROLLING MOBILE DEVICE AUDIO

(71) Applicant: Wavemobile Limited, Richmond (GB)

(72) Inventor: Anthony TIMSON, Richmond (GB)

(21) Appl. No.: 19/341,733

(22) Filed: Sep. 26, 2025

Related U.S. Application Data
(63) Continuation of application No. PCT/GB2024/050799, filed on Mar. 25, 2024.

(30) Foreign Application Priority Data
Mar. 28, 2023 (GB) 2304519.8

(51) Int. Cl. H04B 7/185

(52) U.S. Cl. CPC H04B 7/18506

(57) ABSTRACT

A system includes one or more microphones arranged to capture an audio stream, a transceiver arranged to exchange wireless data signals with mobile communications devices in a vicinity of the one or more microphones, a network element communicatively coupled to the transceiver, and data processing means communicatively coupled to the one or more microphones and the network element. The data processing means are configured to perform operations including comparing data indicative of a waveform within the audio stream with data transmitted within the network element, identifying a communication channel associated with the waveform and over which data is exchanged between the network element and a first mobile communications device via the transceiver based on the comparison, and modifying data exchanged between the network element and the first mobile communications device over the identified communication channel to control an audio output of the first mobile communications device.

### CROSS-REFERENCE TO RELATED APPLICATIONS

This application is a continuation of International Application No. PCT/GB2024/050799, filed Mar. 25, 2024, which claims priority to Great Britain Application No. GB 2304519.8, filed Mar. 28, 2023. Each of the above-referenced patent applications is incorporated by reference in its entirety.

### TECHNICAL FIELD

The present disclosure relates to controlling an audio output of a mobile communications device.

### BACKGROUND

Airlines are increasingly offering in-flight communication services to passengers on commercial flights. For example, a small cell base station and/or Wi-Fi access point may be installed onboard an aeroplane, and arranged to connect to a satellite network and/or an air-to-ground network to enable passengers to access the internet, make phone calls, and send text messages. It is expected that many airlines may offer 5G services on commercial flight in coming years.

The provision of communication services, and in particular voice calls, on aeroplanes may be a cause for concern, as most people would not appreciate the nuisance of fellow passengers engaging in loud or lengthy calls in their vicinity. In addition to negatively affecting the passenger experience, voice calls on flights could be a source of tension or altercations between passengers, leading to safety concerns and a challenging task for cabin crew attempting to diffuse such a situation.

### SUMMARY

According to a first aspect, there is provided a system comprising one or more microphones arranged to capture an audio stream, a transceiver arranged to exchange wireless data signals with mobile communications devices in a vicinity of the one or more microphones, a network element communicatively coupled to the transceiver, and data processing means communicatively coupled to the one or more microphones and the network element, and configured to perform a computer-implemented method. Also provided are the computer-implemented method, a computer program product (such as one or more non-transient storage media) comprising instructions to perform the computer-implemented method, and a data processing system comprising means for carrying out the computer-implemented method.

The computer-implemented method includes comparing data indicative of a waveform within the audio stream with data transmitted within the network element, identifying a communication channel associated with the waveform and over which data is exchanged between the network element and a first mobile communications device via the transceiver based on the comparison, and modifying data exchanged between the network element and the first mobile communications device over the identified communication channel, thereby to control an audio output of the first mobile communications device.

By identifying the communication channel based on a comparison between data representing the waveform and data transmitted within the network component, aspects of the audio output of the first mobile communications device can be controlled to mitigate or remove an undesirable source of audio associated with the first mobile communications device. For example, the data transmitted within the network element may include voice data, in which case the system may be used to control an audio output of a voice call in an environment where voice calls are undesirable and/or not permitted.

The communication channel may include a downlink channel and an uplink channel, in which case modifying the data exchanged between the transceiver and the first mobile communications device may include modifying data transmitted on the downlink channel, as the downlink channel may control the audio output of the first mobile communications device. By contrast, identifying the communication channel may include comparing the data representing the waveform with data transmitted on the uplink channel. In situations where the audio source is separate from the first mobile communications device, for example a user speaking into the first mobile communications device, the waveform within the audio stream is expected to correspond to data on the uplink channel. Additionally, or alternatively, identifying the communication channel may include comparing the data representing the waveform with data transmitted on the downlink channel, for example where the audio source includes a loudspeaker of the mobile communications device. This may be the case, for example, if the first mobile communications device is being used in speakerphone mode, or if a user is listening to music or watching a video streamed onto the first mobile communications device.

The modifying of the data exchanged between the transceiver and the first mobile communications device may be to adjust or suppress a volume of the audio output of the first mobile communications device. For example, reducing the volume of the audio output may mitigate a nuisance caused by a person using the first mobile communications device in speakerphone mode. Furthermore, adjusting or suppressing the volume of the audio output may have the effect of changing the behaviour of the user of the first mobile communications device. For example, reducing the volume of downlink audio received by a user in a voice call may encourage the user to lower the volume of their own speech. In other cases, increasing the volume of audio received by the user may have the desired effect. Other ways of modifying the data exchanged between the transceiver and the mobile communications device are possible, such as inserting an audio signal such as an audio message instructing the user to speak more quietly or end the call, and/or warning the user of consequences of failing to do so.

The operations performed by the data processing means may further include monitoring a characteristic of data exchanged over the identified communications channel, in which case the modifying of the data exchanged between the transceiver and the first mobile communications device may be performed dynamically in dependence on the monitored characteristic. For example, the volume of uplink audio may be monitored, and the volume of the downlink audio adjusted or suppressed in response to the volume of the uplink audio. Such dynamic modification may be performed algorithmically and/or using a machine learning model such as a reinforcement learning model.

In another example, the modifying of the data exchanged between the transceiver and the first mobile communications device includes disconnecting the identified communication channel. In this way, undesired activity can be stopped immediately. Disconnecting the communication channel may be possible even in cases where the system has limited capabilities to otherwise modify the data exchanged over the communication channel, for example because the data is end-to-end encrypted or tamper-resistant.

The operations may include determining that the waveform satisfies one or more criteria, and the modifying of the data exchanged between the network element and the first mobile communications device is conditional on determining that the waveform satisfies the one or more audio criteria. In some cases, it may only be necessary or desirable to modify the audio output of the first mobile communications device if an activity carried out using the first mobile communications device is identified as impermissible. For example, certain phone calls may be permissible or even necessary. However, if a call lasts for too long, or becomes too loud (either instantaneously or sustained over a period of time), action may be taken. Accordingly, the one or more criteria may include a volume or amplitude associated with the waveform exceeding a threshold volume or amplitude, and/or a volume or amplitude associated with the waveform exceeding a threshold volume or amplitude for a threshold period of time, and/or a duration of the waveform exceeding a threshold duration. The volume or amplitude associated with the waveform may for example refer to a peak value or an average value (e.g. moving average) over a period of time.

In an example in which the operations include determining that the waveform satisfies first criteria, the operations may further include determining that the waveform satisfies second criteria, and modifying further data exchanged between the transceiver and the first mobile communications device via the identified communication channel, thereby to further modify the audio output of the first mobile communications device. For example, the first criteria may include a volume associated with the waveform exceeding a first threshold volume, and the second criteria may include a volume associated with the waveform exceeding a second threshold volume, where the second threshold volume is higher than the first threshold volume. In another example, the first criteria may be the duration of the waveform exceeding a first threshold duration, and the second criteria may be the duration of the waveform exceeding a second threshold duration, where the second threshold duration is longer than the first threshold duration. In such cases, the modifying of the data may be to reduce or otherwise modify the volume of the audio output of the mobile communications device, or to insert an audio message into a downlink channel of the communications channel. Further modifying the data may then be to disconnect the communications channel. In this way, the more intrusive action of disconnecting the communications channel may only be carried out if the initial action has not been successful in achieving the desired effect.

The data transmitted within the network element may correspond to wireless data signals exchanged, contemporaneously with a timing of the waveform, between the transceiver and one or more mobile communications devices. For example, the data transmitted within the network element may include data encoded using pulse-code modulation (PCM), and identifying the communication channel associated with the waveform may include decoding the data encoded using PCM to generate a candidate waveform and matching the waveform within the audio stream with the candidate waveform. Alternatively, the comparison could take place in the PCM domain, or in another domain to which the waveform and PCM data are commonly mapped.

Identifying the communication channel associated with the waveform may include matching one or more characteristics of data packets transmitted within the network element with features of the waveform. The data packets may for example be transmitted as an Internet Protocol (IP) stream. The one or more characteristics of the data packets include a timing of the data packets. Identifying the communication channel may include correlating periods of high amplitude of the waveform with periods of high data rate, or a data rate recognisable as a corresponding to a particular action such as Voice over IP (VOIP) on a particular communication channel. In another example, the data packets may indicate a start and/or end of a video or audio stream, and the features of the detected waveform may correspond to an increase and/or decrease in a volume associated with the waveform.

The modifying of the data exchanged between the transceiver and the first mobile communications device may include modifying, replacing, or halting data packets transmitted on the identified communication channel, for example within the network element. The modifying of the data exchanged between the transceiver and the first mobile communications device may be performed in the radio frequency (RF) domain, for example by directly modifying waveforms for transmission by the transceiver.

The one or more microphones and the transceiver may be located onboard an aircraft such as an aeroplane, for example within a cabin of the aircraft, such that the system can be used to control communication and/or entertainment services within the cabin. In this way, the system may provide an effective and safe way to mitigate or avoid the effects of nuisance noise within the cabin. Furthermore, the system may be implemented with relatively few microphones compared with the number of seats in the cabin, meaning that the present solution may be implemented without adding significant weight or wiring complexity to the aircraft.

In examples where the one or more microphones and the transceiver are located onboard an aircraft, the network element may also be located onboard the aircraft, enabling the identification and modification of data on the communication channel to take place locally on the aircraft, which may avoid the need to modify network components at locations on the ground. Nevertheless, in other examples the identification and modification of data on the communication channel may be performed remotely, such as locally to a network component on the ground.

The system may include a base station apparatus of a mobile communications network, in which case the transceiver may be a component of the base station apparatus, and the network element may be a core network element of the mobile communications network, such as a 5G network. Certain types of data, such as voice call data, may not necessarily be encrypted in the core network of the mobile communications network, enabling detailed monitoring of data transmitted within the core network. Alternatively, the system may include a wireless access point of a Wi-Fi network, in which case the transceiver may be a component of the wireless access point.

According to further aspects of the invention, there are provided a computer-implemented method, a data processing system comprising means for carrying out the computer-implemented method, and a computer program product (such as one or more non-transitory storage media) comprising instructions for carrying out the method. The method is for controlling an audio output of a first mobile communications device, and includes receiving an audio stream captured by one or more microphones, monitoring data transmitted within a network element and derived from wireless data signals exchanged between a transceiver and one or more mobile communications devices, comparing data indicative of a waveform within the audio stream with the data transmitted within the network element, identifying a communication channel associated with the waveform and over which data is exchanged between the network element and a first mobile communications device via the transceiver based on the comparison, and modifying data exchanged between the network element and the first mobile communications device over the identified communication channel to control the audio output of the first mobile communications device.

Further features and advantages will become apparent from the following description of preferred embodiments of the invention, given by way of example only, which is made with reference to the accompanying drawings.

### BRIEF DESCRIPTION OF THE DRAWINGS

FIG. 1 shows a schematic plan view of an aeroplane cabin incorporating a system for controlling an audio output of a mobile communications device in accordance with examples.

FIG. 2 is a flow chart representing a first method of controlling an audio output of a mobile communications device in accordance with examples.

FIG. 3 illustrates an example of comparing an audio waveform with waveforms derived from data transmitted within a network element in accordance with examples.

FIG. 4 illustrates an example of comparing an audio waveform with transmission rates for data transmitted within a network element in accordance with examples.

FIG. 5 is a flow chart representing a second method of controlling an audio output of a mobile communications device in accordance with examples.

### DETAILED DESCRIPTION

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the case of explanation and understanding of the concepts underlying the examples.

Embodiments of the present disclosure relate to controlling an audio output of a mobile communications device. In particular, embodiments described herein address problems related to undesired use of mobile devices in certain environments, such as in a cabin of a commercial aircraft.

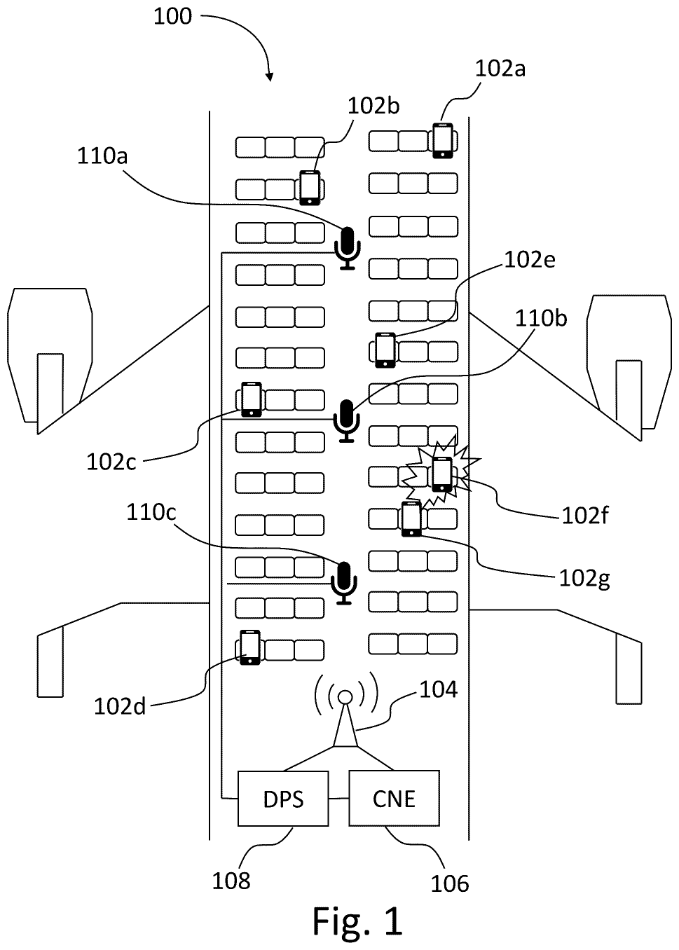

FIG. 1 shows a cabin 100 of an aeroplane on which components of a mobile communication network are installed to provide communication services to users of mobile devices 102a-102g (referred to collectively as mobile devices 102). The mobile devices 102 may include, for example, mobile (cell) phones, laptop computers, tablet computers, and/or any other devices capable of wireless connectivity and comprising audio output means. In this example, the aeroplane is provided with a small-cell base station 104 communicatively coupled to a core network element 106 of a mobile communications network. The core network element 106 may include one or more hubs, switches, gateways or routers arranged to enable communication with a ground network via a satellite network and/or an air-to-ground network.

The base station 104 includes a transceiver comprising one or more antennae arranged to exchange wireless data signals with the mobile devices 102 within the cabin 100 of the aeroplane. Within the meaning of the present disclosure, exchanging wireless data signals between two devices may include either or both of the devices transmitting and/or receiving wireless data signals. The small-cell base station may for example include a base station of a 2G GSM (Global System for Mobile Communications Network) network, a NodeB of a 3G UMTS (Universal Mobile Telecommunication System) network, an eNodeB of a 4G LTE (Long-Term-Evolution) network, and/or a gNodeB of a 5G NR (New Radio) network.

The aeroplane is also provided with an on-board data processing system 108, which is configured or programmed to perform a method of controlling an audio output of one or more of the mobile devices 102. In this example, the data processing system 108 is connected to the core network element 106 in such a manner to enable the data processing system 108 to monitor or otherwise receive data transmitted within the core network element 106 and corresponding to the wireless data signals exchanged between the base station 104 and the mobile devices 102. The data processing system 108 may include a transcoder for transcoding data to be transmitted to the mobile devices 102 (for example within the core network element 106), to enable the data processing system 108 to modify or control audio outputs of the mobile devices 102.

The data processing system 108 is also connected to a set of microphones 110a-110c (referred to collectively as microphones 110) in such a manner to enable to the data processing system 108 to receive and analyse audio data captured using the microphones 110. The microphones 110 may be deployed within the cabin 100 or in a vicinity of the cabin 100, so as to enable the microphones to capture audio resulting from use of the mobile devices 102 within the cabin 100. Examples of audio resulting from use of the mobile devices 102 include audio output by a loudspeaker of one of the mobile devices 102, and the voice of a user of one of the mobile devices 102 making a voice call or video call. Although in this example three microphones are shown, in other examples the number of microphones may be more or less than this. In some examples, only a single microphone may be provided.

Although the system of FIG. 1 shows a base station and core network element of a mobile communications network, in other examples the system may additionally, or alternatively, include a Wi-Fi access point for providing wireless internet access to mobile devices, in which case the methods described herein may be implemented by analysing data transmitted within a corresponding network element such as a router or gateway.

In the example of FIG. 1, a user of the mobile device 102f is taking part in a voice call using the on-board wireless communications facilities provided by the base station 104 and the core network element 106. This behaviour may be prohibited and/or undesirable to other passengers in the cabin 100 (for example if the voice call is prolonged and/or the user's speech is loud). It may therefore be desirable to mitigate or prevent any nuisance caused by the voice call. One option may be for another person in the cabin 100, such as a member of cabin crew, to manually intervene. However, there are various reasons that this may not be an ideal solution, such as wasting cabin crew time and the potential to give rise to an altercation between passengers and/or crew members. The task of identifying the offending passenger could be assisted by arranging a separate microphone to capture audio at each seat in the cabin 100. However, this solution would require a relatively large number of microphones and associated wiring, which would increase the weight of the aeroplane, and would still not alleviate the potential safety concerns. In another example, a phased array microphone system could be used to locate the offending passenger using fewer microphones. This may reduce weight but would not alleviate the issue of requiring manual intervention to mitigate or put a stop to the nuisance behaviour.

In accordance with the present disclosure, an alternative solution is provided in which a waveform corresponding to the user's speech is picked up by one or more of the microphones 110, and compared, using the data processing system 108, with data transmitted within the core network element 106. Based on this comparison, a communication channel may be identified over which the voice call is taking place, and data transmitted via the identified communication channel may be modified in order to control an audio output of the mobile device 102f. In this way, the nuisance behaviour of the user may be mitigated or terminated in an automated fashion. It is noted that in this example the number of microphones 110 is significantly less than the number of seats in the cabin 100, meaning that any additional weight associated with the microphones 110 and associated wiring is relatively small. In some cases, microphones may already be provided within an aircraft cabin for other purposes.

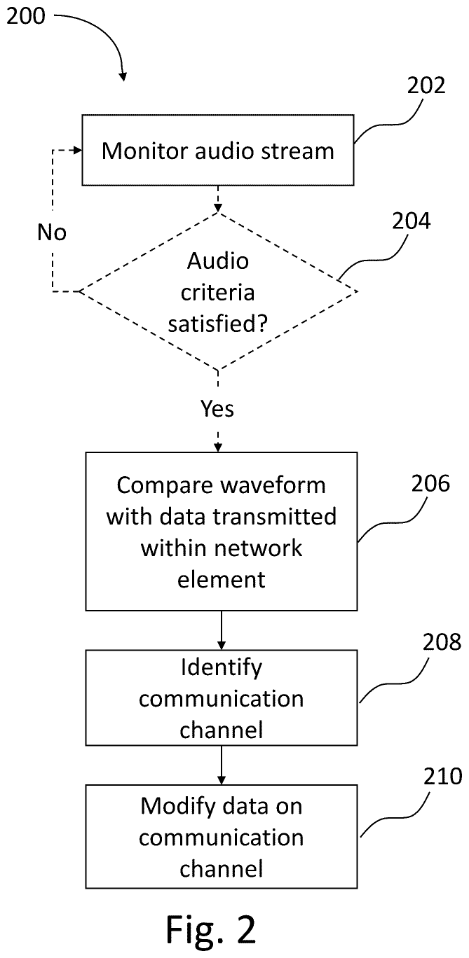

FIG. 2 shows an example of a computer-implemented method 200 for controlling an audio output of a mobile device. The method 200 may be carried out, for example, by a computer or data processing system such as the data processing system 108 of FIG. 1. The method 200 proceeds with monitoring, at 202, an audio stream captured using one or more microphones. The monitoring may be carried out at all times, or may be constrained to take place only at certain times, for example when data is transmitted within a network element coupled to the data processing system (such as the core network element 106 of FIG. 1) The monitoring may include measuring various characteristics of a waveform within the audio stream, such as an amplitude/volume associated with the waveform, such as a peak value or (moving) average value. Alternatively, or additionally, an amplitude/volume associated with a particular frequency range (such as the frequency range corresponding to human speech or an output of a mobile device loudspeaker) may be measured. The waveform may include the entirety of the audio stream, or may include part of the audio stream, for example a component of the audio stream within particular frequency range or a waveform generated by application of a source separation algorithm to the audio stream.

The method 200 proceeds with determining, at 204, whether one or more criteria are satisfied by the audio stream or a waveform within the audio stream. The criteria may for example include a volume or amplitude exceeding a threshold volume or amplitude, and/or a volume or amplitude exceeding a threshold volume or amplitude for a threshold period of time. The volume or amplitude associated with the waveform may for example refer to a peak value or an average value (e.g. moving average) over a period of time. In another example, a waveform within the audio stream may be identified as being associated with a single source such as a person talking, in which case the one or more criteria may include a duration of the waveform exceeding a threshold duration. In another example, the audio criteria may include identifying a waveform as being generated by a particular type of source, such as a human voice or a loudspeaker of a mobile device. Such identification may be performed using a rules-based or heuristic method or a suitable audio filter, and/or using a machine learning model. The audio criteria may for example be dependent on an output of a classification model or regression model trained to identify particular types of sound, such as human voices, within an audio stream. A suitable machine learning model may be a recurrent neural network (RNN) or long short-term memory (LSTM) model, or a transformer, trained using supervised learning to identify particular sounds.

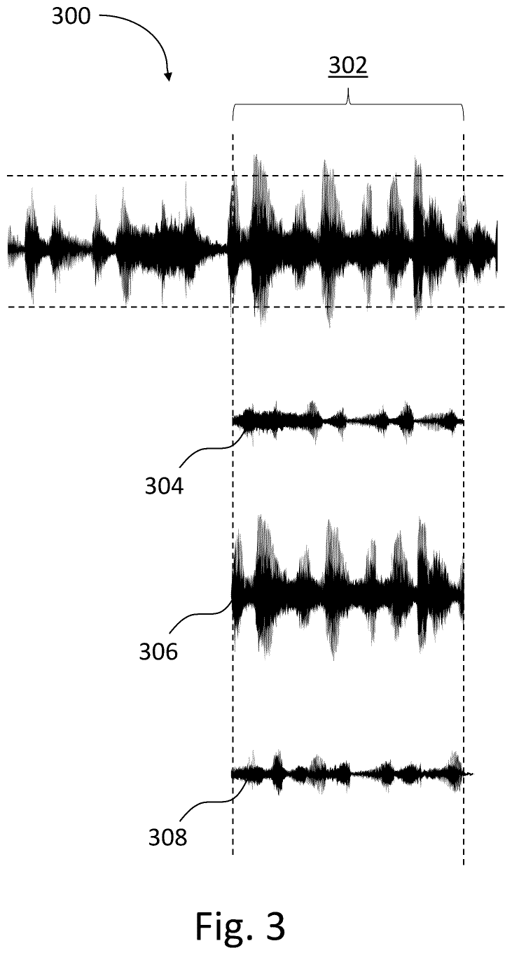

FIG. 3 shows a waveform 300 captured by a microphone. It is observed that during a period 302, a peak amplitude of the waveform 300 exceeds a threshold amplitude (represented by horizontal dashed lines) multiple times. In this example, the period 302 represents a threshold duration of time, and it is determined that the waveform 300 satisfies criteria including the peak amplitude exceeding the threshold amplitude continually or continuously for more than the threshold duration of time. The criteria may additionally, or alternatively, include an average amplitude exceeding a threshold value for more than a threshold duration of time. In a further example, a machine learning model may be used to identify a portion of the waveform 300 as corresponding to a particular type of audio source.

If it is determined at 204 that the audio stream or waveform does not satisfy the one or more criteria, then no further action is taken and the method 200 may return to step 202 and continue to monitor the audio stream from the microphone.

If it is determined at 204 that the audio stream or waveform satisfies the one or more criteria, then the method 200 proceeds to 206 where data indicative of the audio stream or waveform is compared with data transmitted within a network element (such as the core network element 106) and derived from wireless data signals exchanged between a transceiver (such as a transceiver of the base station 104) and one or more mobile communications devices (such as the mobile communications devices 102) in a vicinity of the microphone. The audio stream or waveform may be compared with uplink data (for example corresponding to speech of users of the mobile communications devices in the vicinity of the microphone, and/or may be compared with downlink data (for example corresponding to an audio output of the mobile communications devices in the vicinity of the microphone).

In one example, the comparing may include searching for a communication channel used by one of the mobile communications devices at the time when the waveform satisfying one or more criteria is captured. In another example, the comparing may involve comparing the captured waveform with one or more candidate waveforms derived from data transmitted within the network element. The comparison may for example be performed using a correlation function or any other suitable sample-based approach. The comparison may involve a direct comparison between the waveforms, or data corresponding to the waveforms may be mapped to a different domain prior to the comparison. For example, data transmitted within the network element may include data encoded using pulse-code modulation (PCM), and comparing the captured waveform to the data transmitted within the network element may include decoding the data encoded using PCM to generate one or more candidate waveforms, and matching the candidate waveform with one of the candidate waveforms. FIG. 3 shows three candidate waveforms 304, 306, 308 transmitted on different communication channels and derived from data transmitted within the network element contemporaneously with the portion of the waveform 300 captured during the period 302. In this example, comparing the captured waveform 300 with data transmitted within the network element may include comparing each of the candidate waveforms 304, 306, 308 with the portion of the captured waveform 302.

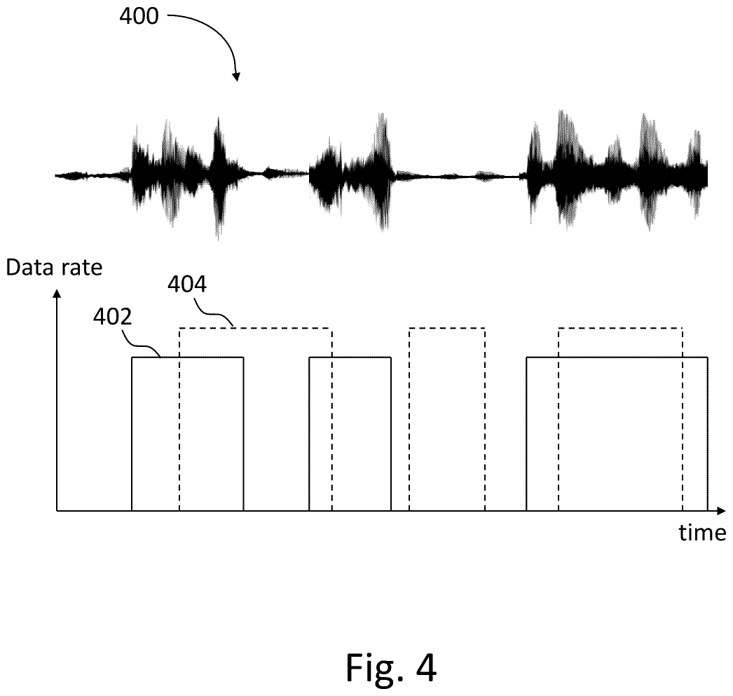

In another example, comparing data indicative of the captured waveform with data transmitted within the network element may include comparing one or more characteristics of data packets transmitted within the network element with features of the waveform. The one or more characteristics may include a timing of the data packets. For example, it may be determined that data packets on a common communication channel or having a common destination may be transmitted, or a rate of transmission may increase or otherwise change, during a period corresponding to the waveform satisfying one or more criteria. In the case of a voice call or VoIP, in order to reduce power consumption and network load, transmission of data may be paused, or the transmission rate may be reduced, when no audio input is detected. Comparing the data indicative of the captured waveform with data transmitted within the network element may therefore include correlating or matching periods of high audio amplitude with periods of data transmission or periods of high data rate. Such methods may be suitable for comparing data even in the event that the data is end-to-end encrypted. FIG. 4 illustrates transmission rates of data packets on two communication channels. It is observed that times at which the transmission rate for the first communication channel 402 (shown using solid lines) correlates with times at which the amplitude of the waveform 400 is high. By contrast, times at which the transmission rate for the second communication channel 404 (shown using dashed lines) does not correlate with the amplitude of the waveform 400.

Another characteristic of data packets within the network element that may be compared with features of the captured waveform is a timing at which a transmission rate of the data packets corresponds to a transmission rate associated with a known activity. For example, it may be determined that, at certain times, the transmission rate of data packets with a common destination corresponds with a transmission associated with a certain type of VOIP call. These times may then be compared with times at which the captured waveform has particular features, for example a high amplitude or being identified as corresponding to a human voice. In other examples, characteristics of data packets may include timings of specific data packets or specific types of data packets, such as data packets identifiable as indicating a start or end of a video or audio stream.

In a further example still, comparing data indicative of the captured waveform with data transmitted within the network element may use a machine learning model. For example, a machine learning model may be trained to process data corresponding to the captured waveform and data transmitted on one or more candidate communications channel, to identify a communications channel associated with the waveform. Such a model may for example be a binary or multi-class classification model, and may be trained using supervised learning with training data comprising audio waveforms and, for each audio waveform, sets of network data each labelled to indicate whether the network data corresponds to the audio waveforms.

The method 200 continues with identifying, at 208, a communication channel associated with the captured waveform, based on an outcome of the comparison at 206. The identified communication channel includes a portion between the network element and the mobile device, where audio corresponding to the captured waveform may either be generated by, or received by, the mobile device. The portion of the communication channel between the mobile device and the network element may include an uplink channel and a downlink channel.

In the context of the present disclosure, data exchanged over a communication channel may refer to data exchanged between a common two or more devices, for example during a communication session. The identified communication channel may for example be established using Session Internet Protocol (SIP), User Datagram Protocol (UDP), Real-time Transport Protocol (RTP), WebRTP, H.323, and/or any other suitable protocol(s) such as connection-oriented protocols and/or connectionless protocols. The communication channel may for example be defined by a common IP address (or pair of IP addresses) indicated in metadata of data packets transmitted within the network element. Data may be exchanged over the identified communication channel as an Internet Protocol (IP) stream or any other form of data stream. The identified communications channel may for example include a SIP trunk.

In the example of FIG. 1, the identified communication channel is used to exchange data, via the core network element 106, between the mobile device 102f and one or more other devices (for example one or more devices remote from the aircraft). In the example of FIG. 3, the communication channel on which the candidate waveform 306 is transmitted may be identified as corresponding to the portion of the waveform 300 captured within the period 302, due to the similarity of these waveforms. In the example of FIG. 4, the communication channel 402 may be identified as corresponding to the waveform 400, due to the correlation of the data transmission rate with the audio amplitude.

The method 200 continues with modifying, at 210, data exchanged over the communication channel identified at 208, thereby to control an audio output of the first mobile device. The data may be modified in the radio frequency (RF) domain, for example by directly modifying one or more characteristics (such as amplitude) of a waveform for transmission by the transceiver to the first mobile device. Alternatively, data may be modified in the IP or bitstream domain, for example within the network element, for example by modifying, replacing, or halting data packets within the network element. Modifying the data exchanged over the communication channel may include transcoding the data to enable said modification to take place, depending on the encoding/compression schemes implemented on the communication channel. The controlling of the audio output may be temporary, for example lasting for a predetermined amount of time or until the audio stream no longer satisfies the one or more criteria, or may persist for as long as the communication channel remains open.

In some examples, modifying the data exchanged over the identified communication channel is to adjust or suppress a volume of the audio output. In an example where the captured audio waveform corresponds to the audio output of the mobile device (e.g. while the user listens to music, watches a video, or takes part in a call using speakerphone), the volume of the audio output may be reduced to an acceptable volume. In an example in which the captured waveform corresponds to an audio input of the mobile device (e.g. the voice of a user of the mobile device taking part in a call), then reducing the volume of the audio output may encourage the user to speak more quietly. The adjustment of the audio level (or any other characteristic of the audio) may be performed according to one or more rules. For example, the level of adjustment may be dependent on an amplitude or volume associated with the captured waveform. Alternatively, the adjustment of the audio level may be carried out by a machine learning model, such as a reinforcement learning model, which may be trained using a reward function that penalises increases in amplitude of the waveform and rewards decreases in amplitude of the waveform.

In another example, modifying the data exchanged over the identified communication channel includes disconnecting the identified communications channel, or otherwise ceasing to transmit data over the identified communications channel. In this way, any nuisance behaviour may be brought to an end immediately. This solution may be possible even in cases where options for modifying the data exchanged over the communication channel are limited, for example because the data is encrypted and/or tamper-resistant.

It is to be understood that step 204 in FIG. 2 is optional. In other examples, there may be no determination of whether a waveform satisfies a set of audio criteria. Instead, the monitored audio stream may be compared continually or continuously with data in the network component. In this case, a communication channel may be identified that carries data corresponding to a portion of the audio stream, or a waveform within the audio stream. The identification of such a communication channel may be indicative of a prohibited or undesirable action (such as a voice call or use of a loudspeaker to stream music or video), in which case action may be taken to modify data on the communication channel. In other examples, a determination of whether the audio stream or waveform satisfies one or more criteria may only take place in the event that a corresponding communication channel is identified.

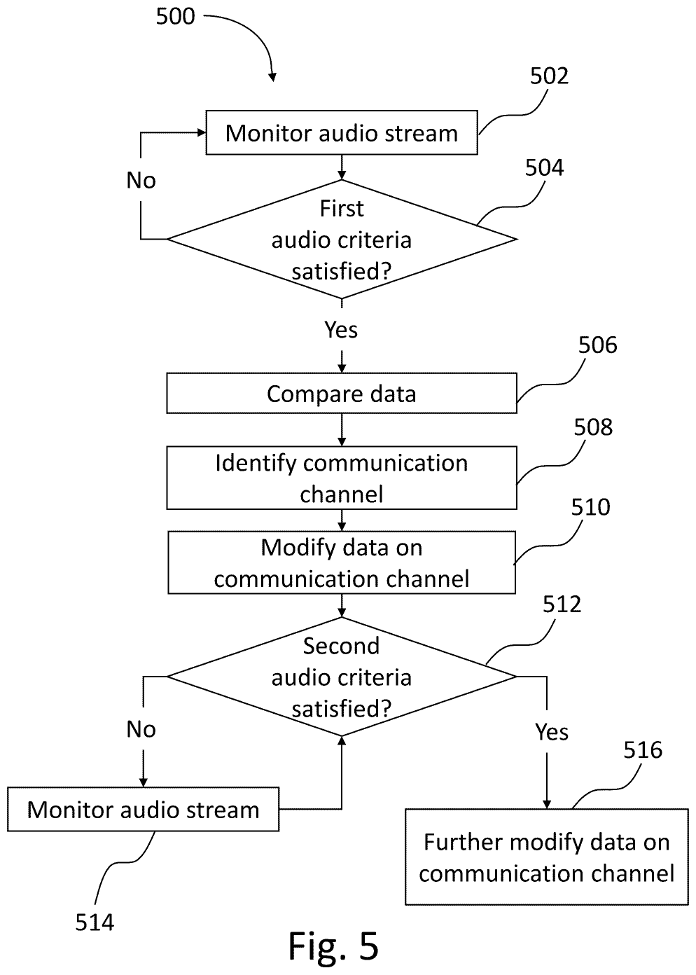

FIG. 5 shows a further example of a computer-implemented method 500 for controlling an audio output of a mobile device. The method 500 may also be carried out by a computer or data processing system such as the data processing system 108 of FIG. 1. Steps 502-510 of the method 500 of FIG. 5 may correspond substantially to steps 202-210 of the method 200 of FIG. 2, with step 504 determining whether a first set of criteria are satisfied by the audio stream or a waveform within the audio stream. The first set of criteria may for example include an amplitude of volume associated with the waveform exceeding a first threshold value, or an amplitude or volume associated with the waveform exceeding a threshold value for a first threshold amount of time. The modifying of data at 510 may for example be to reduce or otherwise adjust a volume of an audio output of the mobile device. Alternatively, the modifying of data at 510 may be to insert an audio message into the downlink channel requesting that the user reduces the volume of the audio source and/or warning of further consequences if the volume of the audio source is not reduced.

The method 500 continues with determining, at 512, whether a second set of criteria are satisfied by the audio stream or a waveform within the audio stream. The second set of criteria may for example include an amplitude of volume associated with the waveform exceeding a second threshold value which is higher than the first value, or an amplitude or volume associated with the waveform exceeding a threshold value for a second threshold amount of time which is longer than the first threshold amount of time.

If it is determined at 512 that the audio stream or waveform does not satisfy the second set of criteria, then no further action is taken and the method 500 may return to step 514 and continue to monitor the audio stream from the microphone.

If it is determined at 512 that the audio stream or waveform satisfies the one or more criteria, then the method 500 proceeds to 516 in which data exchanged over the communication channel identified at 508 is further modified, thereby to further control the audio output of the first mobile device. The further modifying of the data may for example be to further adjust the volume of the audio output. Alternatively, the further modifying of the data may include disconnecting the identified communications channel.

By controlling the audio output of the mobile device in two stages, the method 500 may give the user a chance to modify or refrain from nuisance behaviour before taking a more drastic action such as disconnecting the communication channel. Further stages could also be added, for example with each stage incrementally adjusting the volume of the audio output. It will be appreciated that a multi-stage and/or multi-threshold method could be applied in different ways, for example by testing the audio stream against multiple volume thresholds at the same time and taking an action dependent on which threshold is exceeded. Furthermore, the order of operations in the method 500 is shown only as an example and other permutations of the same operations could be used to achieve an equivalent result.

At least some aspects of the examples described herein comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples. Further embodiments are envisaged. For example, systems as discussed herein may be deployed in other settings in which use of mobile devices may be a nuisance or otherwise undesirable, such as in art galleries, museums, or certain types of sport venue.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A system comprising:
one or more microphones arranged to capture an audio stream;
a transceiver arranged to exchange wireless data signals with mobile communications devices in a vicinity of the one or more microphones;
a network element communicatively coupled to the transceiver; and
a data processing system communicatively coupled to the one or more microphones and the network element, and configured to perform operations including:
comparing data indicative of a waveform within the audio stream with data transmitted within the network element;
identifying, based on the comparison, a communication channel associated with the waveform and over which data is exchanged between the network element and a first mobile communications device via the transceiver; and
modifying data exchanged between the network element and the first mobile communications device over the identified communication channel, thereby to control an audio output of the first mobile communications device.

2. The system of claim 1, wherein:
the communication channel comprises a downlink channel and an uplink channel; and
modifying the data exchanged between the transceiver and the first mobile communications device comprises modifying data transmitted on the downlink channel.

3. The system of claim 2, wherein identifying the communication channel comprises comparing the data representing the waveform with data transmitted on the uplink channel.

4. The system of claim 1, wherein the modifying of the data exchanged between the transceiver and the first mobile communications device is to adjust or suppress a volume of the audio output of the first mobile communications device.

5. The system of claim 1, wherein:
the operations comprise monitoring a characteristic of data exchanged over the identified communications channel; and
the modifying of the data exchanged between the transceiver and the first mobile communications device is performed dynamically in dependence on the monitored characteristic.

6. The system of claim 1, wherein the modifying of the data exchanged between the transceiver and the first mobile communications device comprises one or more of:
disconnecting the identified communication channel; or
causing the first mobile communications device to output an audio message.

7. The system of claim 1, wherein:
the operations include determining that the waveform satisfies one or more criteria; and
the modifying of the data exchanged between the network element and the first mobile communications device is conditional on determining that the waveform satisfies the one or more criteria.

8. The system of claim 1, wherein the data processing system comprises a transcoder configured to transcode data exchanged over the identified communication channel, thereby to facilitate the controlling of the audio output of the first mobile communications device.

9. The system of claim 1, wherein the data transmitted within the network element corresponds to wireless data signals exchanged, contemporaneously with a timing of the waveform, between the transceiver and one or more mobile communications devices.

10. The system of claim 1, wherein:
the data transmitted within the network element includes data encoded using pulse-code modulation (PCM); and
identifying the communication channel associated with the waveform comprises:
decoding the data encoded using PCM to generate a candidate waveform; and
matching the waveform within the audio stream with the candidate waveform.

11. The system of claim 1, wherein identifying the communication channel associated with the waveform comprises matching one or more characteristics of data packets transmitted within the network element with features of the waveform.

12. The system of claim 11, wherein the one or more characteristics of the data packets include a timing of the data packets.

13. The system of claim 1, wherein the modifying of the data exchanged between the transceiver and the first mobile communications device comprises modifying, replacing, or halting data packets transmitted on the identified communication channel.

14. The system of claim 1, wherein the microphone and the transceiver are located onboard an aircraft.

15. The system of claim 14, wherein the network element is located onboard the aircraft.

16. The system of claim 1, comprising a base station apparatus of a mobile communications network, wherein:
the transceiver is a component of the base station apparatus; and
the network element is a core network element of the mobile communications network.

17. The system of claim 16, wherein the base station apparatus and the core network element are configured to exchange data with mobile communications devices in accordance with the 5G wireless communication standard.

18. The system of claim 1, comprising a wireless access point of a Wi-Fi network, wherein the transceiver is a component of the wireless access point.

19. A computer-implemented method of controlling an audio output of a first mobile communications device, the method comprising:
receiving an audio stream captured by one or more microphones;
monitoring data transmitted within a network element and derived from wireless data signals exchanged between a transceiver and one or more mobile communications devices;
comparing data indicative of a waveform within the audio stream with the data transmitted within the network element;
identifying, based on the comparison, a communication channel associated with the waveform and over which data is exchanged between the network element and a first mobile communications device via the transceiver; and
modifying data exchanged between the network element and the first mobile communications device over the identified communication channel, thereby to control the audio output of the first mobile communications device.

20. One or more non-transitory storage media comprising machine-readable instructions which, when executed by one or more processors, cause the one or more processors to carry out operations comprising:
receiving an audio stream captured by one or more microphones;
monitoring data transmitted within a network element and derived from wireless data signals exchanged between a transceiver and one or more mobile communications devices;
comparing data indicative of a waveform within the audio stream with the data transmitted within the network element;
identifying, based on the comparison, a communication channel associated with the waveform and over which data is exchanged between the network element and a first mobile communications device via the transceiver; and
modifying data exchanged between the network element and the first mobile communications device over the identified communication channel, thereby to control the audio output of the first mobile communications device.
